(19) United States
(12) Patent Application Publication
(10) Pub. No.: US 2007/0246424 A1
(43) Pub. Date: Oct. 25, 2007

(54) Process For Producing Ship Ballast Water, Ship Ballast Water Producing Apparatus And Use Thereof

(75) Inventors: Hironari Honda, Koto-ku (JP); Kakichi Itoh, Koto-ku (JP); Tatsumi Shimono, Minato-ku (JP); Takaji Akiya, Chuo-ku (JP)

Correspondence Address: FITCH, EVEN, TABIN & FLANNERY, P. O. BOX 18415, WASHINGTON, DC, 20036, US

(73) Assignees: MITSUBISHI RAYON CO., LTD., Minato-ku, Tokyo (JP); WATER RE-USE PROMOTION CENTER, Chuo-ku, Tokyo (JP)

(21) Appl. No.: 11/547,190

(22) PCT Filed: Mar. 29, 2005
(86) PCT No.: PCT/JP05/05971

§ 371 Date: Jan. 3, 2007

(30) Foreign Application Priority Data
Mar. 29, 2004 (JP) 2004-095980
Sep. 9, 2004 (JP) 2004-261854

(51) Int. Cl. C02F 1/44; B01D 33/50

(52) U.S. Cl. 210/636; 210/411

(57) ABSTRACT

A process for producing ship ballast water includes removing microorganisms from seawater by passing the seawater through a microorganism filtration membrane, and backwashing the microorganism filtration membrane to clean the microorganism filtration membrane. Microorganisms living in seawater can be removed in a manner which does not kill the microorganisms.

### TECHNICAL FIELD

The present invention relates to a process and apparatus for producing ship ballast water (hereinafter, also simply referred to as “ballast water”) in which microorganisms have been removed, and which is introduced to a ship for stabilizing its center of gravity while the ship is traveling.

### BACKGROUND ART

There are cases where a crude oil tanker, an ore carrying ship, an automobile carrying ship, or the like travels under conditions with an empty load or small amount of cargo load. In such cases, the hull of a ship may be lifted up due to the buoyancy force. This situation may result in extremely dangerous conditions for the traveling ship, such as a condition in which its screw propeller or rudder does not sink below the surface, or a condition in which the ship traveling on the surface is significantly affected by wind and impairs controllability. For this reason, ships typically carry ballast water constituting 30% to 40% by weight of a typical cargo load weight in order to adjust the buoyancy while the ships are under way.

For example, transportation by crude oil tankers is performed by traveling between oil producing countries and oil consuming countries. A crude oil tanker traveling from an oil consuming country to an oil producing country carries no cargo, and while in the oil consuming country, seawater surrounding the berth, or the like is introduced into an oil tank of the ship for use as ballast water. On the other hand, the ship loaded with ballast water discharges the ballast water inshore or in a port of the oil producing country, and again loads crude oil there.

In recent years, ballast water discharged from ships has become a serious international concern because microorganisms which did not originally live in a particular sea area are brought in, and cause destruction of marine ecosystems, which in turn causes both significant damage to the life of people who live around that sea area and global destruction of marine environments. With this being the situation, for the purpose of removing microorganisms from ballast water, various types of methods are under consideration on an international scale.

As methods for removing microorganisms from seawater which is to be introduced as ballast water, for example, a method for killing microorganisms by heating seawater (Japanese Patent Laid-Open Publication No. 2003-181443), a method for deactivating microorganisms by applying ultraviolet rays to seawater (Japanese Publication of unexamined PCT Patent Application No. 2000-515803, and Japanese Patent Laid-Open Publication No. Hei 11-265684), a method for killing microorganisms by passing seawater through an electrolytic apparatus (Japanese Patent Laid-Open Publication No. 2003-334563), a method for treatment using iodine (Japanese Publication of unexamined PCT Patent Application No. 2002-504851), a method for treatment using hypochlorous acid (Japanese Patent Laid-Open Publication No. Hei 04-322788), and the like have been proposed.

### DISCLOSURE OF INVENTION

However, the method in which seawater is heated is not cost effective depending on how heating energy is obtained, and the method has difficulty in completely destroying microorganisms. Further, the method of applying ultraviolet rays to seawater requires enormous amounts of electrical power in order to destroy or deactivate all microorganisms, and also sharply increases the cost of setting up equipment because a large number of UV devices must be provided when a high rate of flow of seawater is to be treated, or for other reasons. Further, the method of passing seawater through an electrolytic apparatus to destroy microorganisms utilizing the sterilizing effect of free chlorine produced by electrolysis is not able to destroy all microorganisms because there are some microorganisms that are not destroyed by free chlorine. Further, the method of treating seawater through the use of an agent, such as iodine, hypochlorous acid, or the like requires a high concentration of agent in order to destroy certain types of bacteria, and therefore use of a large amount of neutralizer is inevitable for neutralizing seawater after the treatment.

As described above, in the methods of killing microorganisms living in seawater, ensuring complete destruction of microorganisms is difficult, and the influence of contamination caused by dead microorganisms on ecosystems is also of concern. In addition, because a small amount of remaining microorganisms which are not killed grow in number during transportation, development of a method for completely eliminating such microorganisms is eagerly desired. Although a method of passing seawater through a filtration membrane to thereby eliminate microorganisms from the seawater is known (Japanese Patent Laid-Open Publication No. 2003-154360), membrane filtered water obtained by this method is used, for example, in the process of washing fishery products such as fish and shellfish, and is not intended for use as ship ballast water.

According to one aspect of the present invention, there are provided a producing process and a producing apparatus for producing ship ballast water, in which microorganisms living in seawater are removed in a manner which does not destroy the microorganisms, and there is also provided use of membrane filtered water obtained by such a ship ballast water producing process, for use as ship ballast water.

Under the circumstances, the present inventors have accomplished the present invention as a result of their diligent studies in which they reached findings, including the following: In a process for producing ship ballast water, the process comprising the steps of removing microorganisms from seawater by passing the seawater through a filtration membrane capable of removing microorganisms, and backwashing the filtration membrane to clean the filtration membrane, by storing membrane filtered water obtained through the step of removing microorganisms in, for example, a ballast water reservoir, the water can be introduced into a ship when necessary; by performing each of the above-described steps in a ship and supplying the thus-obtained membrane filtered water to a ballast water tank provided within the ship, equipment to be set up on the ground, setup space, and ground workers become unnecessary; and although seawater in a port area in which a ship is staying contains a relatively high content of oil which contaminates the filtration membrane, the treatment efficiency of the filtration membrane is improved by pre-removing the oil content before the seawater is treated by the filtration membrane.

In other words, according to one aspect of the present invention, there is provided a process for producing ship ballast water, the process comprising the steps of removing microorganisms from seawater by passing the seawater through a microorganism filtration membrane; and backwashing the microorganism filtration membrane to clean the microorganism filtration membrane.

Further, in the above-described process for producing ship ballast water, it is preferable that at least oil content in the seawater is pre-removed before the seawater is treated through the microorganism filtration membrane.

Further, in the above-described process for producing ship ballast water, it is preferable that the microorganism filtration membrane is a hollow fiber membrane.

Further, in the above-described process for producing ship ballast water, it is preferable that the oil content in the seawater is removed by absorption using a hydrophobic absorbent.

According to another aspect of the present invention, there is provided a ship ballast water producing apparatus, comprising seawater supply means for supplying seawater; a microorganism filtration membrane device for removing microorganisms from the supplied seawater; and backwash water supply means for supplying backwash water to the microorganism filtration membrane device.

Further, it is preferable that the above-described ship ballast water producing apparatus further comprises a ballast water reservoir for storing membrane filtered water.

Further, in the above-described ship ballast water producing apparatus, it is preferable that an oil content removal device for removing at least oil content from the seawater is provided upstream of the microorganism filtration membrane device.

Further, in the above-described ship ballast water producing apparatus, it is preferable that the microorganism filtration membrane device is either an immersion type hollow fiber membrane device, or is a pressure type hollow fiber membrane device.

According to still another aspect of the present invention, there is provided use of membrane filtered water as ship ballast water, wherein the membrane filtered water is obtained through the step of removing microorganisms in the above-described process for producing ship ballast water.

According to the present invention, by passing seawater through a microorganism filtration membrane to remove microorganisms from the seawater, microorganisms living in seawater can be removed in a manner which does not kill the microorganisms, and the thus-obtained membrane filtered water can be used as ship ballast water.

### BRIEF DESCRIPTION OF DRAWINGS

FIG. 1 is a schematic diagram showing an example of a ballast water producing apparatus to be set up on a ship.

FIG. 2 is a flow diagram of a ballast water producing apparatus as used in Example 1.

FIG. 3 is a flow diagram of a ballast water producing apparatus as used in Example 2.

### BEST MODE FOR CARRYING OUT THE INVENTION

An embodiment of the present invention will be described below. For example, seawater in a port area in which a ship stays can be used as seawater for use in a process for producing ballast water according to the present embodiment. The seawater for use herein usually contains an oil content of 0.05% to 1.0% in addition to microorganisms, and has a turbidity of 1 to 100 NTUs, but is not necessarily limited to such seawater. Among microorganisms living in seawater, coliform bacteria, cholera vibrios, enterococci, larvae of daphnia, larvae of North Pacific starfish, larvae of Asian laminaria, larvae of zebra mussels, toxic seaweed, and the like are particularly considered as microorganisms which are to be matters of international concern. Most of these microorganisms have a size of a few micrometers, and those of the smallest size have a size of 0.3 to 0.5 μm.

The step of removing microorganisms as performed in a process for producing ballast water according to the present embodiment is a step in which microorganisms living in seawater are removed by passing the seawater through a microorganism filtration membrane. The microorganism filtration membrane as used herein includes a microfiltration (MF) membrane, an ultrafiltration (UF) membrane, and the like, such as a hollow fiber membrane, a flat membrane, a tubular membrane, and the like. Among these, a hollow fiber membrane is preferable in that it can provide the largest filtration area per unit volume.

The hollow fiber membrane uses multiple hollow fibers arranged in parallel, and has a hollow structure, in which, in communication with a hole forming the hollow structure, multiple pores communicating with this hole on a membrane surface are further formed. As the hollow fiber membrane, there are an external pressure type and an inner pressure type. In the present embodiment, when a microfiltration membrane is used as the microorganism filtration membrane, the pores in the hollow fiber membrane have a diameter of 0.01 to 0.4 μm, and preferably have a diameter of 0.01 to 0.3 μm. When an ultrafiltration membrane is used, the pores in the hollow fiber membrane have a diameter of 0.002 to 0.01 μm. The size of microorganisms, such as bacteria, larvae, and the like, living in seawater is usually in the order of a few micrometers, and those of the smallest size have a size of about 0.3 to 0.5 μm. Therefore, these bacteria, larvae, and other microorganisms living in seawater can be almost completely removed through the use of a hollow fiber membrane having pores of a diameter as described above. Although backwashing is also performed in order to remove microorganisms adhering to the membrane surface and thereby restore its filtering capability, use of an external pressure type hollow fiber membrane is preferable in that, in addition to such backwashing, an operation of causing bubbles to form during filtration to release and remove microorganisms adhering to the membrane surface can be performed from outside the membrane surface.

Further, the hollow fiber membrane may be used in the form of either an immersion type hollow fiber membrane device, or a pressure type hollow fiber membrane device. The immersion type hollow fiber membrane device is used in a process for removing microorganisms from seawater through suction applied using a suction pump on a side of the holes in the hollow fibers of this device which is immersed in a seawater reservoir. The pressure type hollow fiber membrane device is used in a process for removing microorganisms from seawater by supplying the seawater into hollow fibers loaded within a pressure vessel using a pressure pump. The immersion type hollow fiber membrane device and the pressure type hollow fiber membrane device are both able to continue filtration while simultaneously cleaning the membrane surface, as described above, by generating micro-bubbles from below the hollow fiber membrane to cause microorganisms adhering to the hollow fiber membrane to be released as desired.

Raw material for the microfiltration membrane as used in the present embodiment includes polyethylene, polypropylene, polysulfone, polyvinylidene chloride, polyvinylidene fluoride, chlorinated polyethylene, chlorinated polypropylene, polyacrylonitrile, cellulose acetate, and the like.

Although the method for passing seawater through the microorganism filtration membrane is not particularly limited, two or more microorganism filtration membrane devices incorporating microorganism filtration membranes may be provided in a parallel arrangement. In such cases, while one microorganism filtration membrane device is in the step of backwashing, another microorganism filtration membrane device can perform the step of removing microorganisms, and it is therefore possible to continuously produce a large amount of membrane filtered water.

The step of backwashing as performed in a ballast water producing process is a step in which the microorganism filtration membrane is cleaned through backwashing. In the step of removing microorganisms, microorganisms or other substances that cause clogging of the membrane adhere to the microorganism filtration membrane with the passage of time, resulting in an increase in membrane differential pressure between an inlet and an outlet of the membrane. For this reason, seawater filtration is stopped to backwash the microorganism filtration membrane by use of membrane filtered water as cleaning water. By performing the step of backwashing, the filtering function of the microorganism filtration membrane is restored. After the step of backwashing is completed, the process transfers back to the step of removing microorganisms, and repetition of these steps allows filtration to be performed for a long period of time.

In the process of producing ballast water according to the present embodiment, pre-removal of oil content from seawater before the treatment through the microorganism filtration membrane is preferable in terms of prevention of clogging of the microorganism filtration membrane, and which can prevent deterioration of the filtering function. More specifically, although oil content in seawater is also captured by the microorganism filtration membrane, in contrast to microorganisms and other suspended substance, oil content which has adhered to the membrane surface cannot be easily removed by the above-described bubbling, or in the backwashing step. Such oil content causes the microorganism filtration membrane to become clogged, and results in deterioration of the filtering function.

The method for removing oil content from seawater is not particularly limited, and a known oil water separation device (oil content removal device) can be used. As the oil water separation device, a device that uses a hydrophobic absorbent is preferable because it is an easy method and exhibits a high ability to absorb oil content. As the hydrophobic absorbent, a nonwoven fabric filter, powder, and a hollow fiber membrane that are made of oleophilic material, such as polyethylene, polypropylene, or the like, can be used. More specifically, use of an oil-content absorbent “DIAMARS”® enables highly efficient removal of oil content. By treating seawater with, for example, 0.05% to 1.0% oil content through the step of removing oil content from seawater, it is possible to obtain seawater having 0.005% to 0.02% oil content.

Removal of oil content from seawater is necessary in terms of preventing contamination of the microorganism filtration membrane, and in order to reduce loads imposed on the microorganism filtration membrane for removal of microorganisms, it is preferable to pre-remove suspended substance from seawater. The method for removing suspended substance from seawater is not particularly limited, and a known turbidity removal device can be used. The turbidity removal device includes a sand filtering device, a device having a nonwoven fabric filter made of polyethylene or polypropylene, a turbidity removal device having a long fiber bundle which allows absorption of suspended substance into the bundle of polyester fibers contained in a sand filtering tank, and the like. Using the oil-content absorbent “DIAMARS”® is preferable in that both oil content and suspended substance can be efficiently removed.

When the process for producing ship ballast water according to the present embodiment is performed on the ground, membrane filtered water obtained through the step of removing microorganisms can be stored in a ballast water reservoir, and ballast water can be supplied from the ballast water reservoir to a ship staying in a port at a high flow rate. Therefore, it becomes unnecessary to extend a period of stay of the ship in order to introduce ballast water. Further, when the process for producing ship ballast water according to the present embodiment is performed in a ship, equipment to be set up on the ground, setup space, and ground workers become unnecessary. When ballast water is produced in a ship, ballast water is usually produced while the ship is being anchored, and the ballast water from which microorganisms have been removed is supplied to a ballast water tank provided within the ship until the amount of ballast water supplied reaches a predetermined amount.

The ballast water producing apparatus according to the present embodiment may be set up on the ground, or may be set up on a ship. The ballast water producing apparatus of a type to be set up on the ground includes seawater supply means for supplying seawater, or, for example, seawater in a port area in which ships stay; a microorganism filtration membrane device for removing microorganisms from the supplied seawater; backwash water supply means for supplying backwash water to the microorganism filtration membrane device; and a ballast water reservoir for storing membrane filtered water. It is preferable that the ballast water producing apparatus further includes an oil content removal device for removing oil content from seawater, upstream of the microorganism filtration membrane device. Further, a turbidity removal device may be provided as needed, downstream of the oil content removal device. The seawater supply means is means for supplying seawater to the microorganism filtration membrane device, and includes a seawater pump and a seawater intake pipe, one end of which has an opening positioned in the sea, and another end of which is connected to the seawater pump. The ballast water reservoir has no particular limitation to limit the number of reservoirs to be provided, the type of reservoir, and the like. Equipment for use in connection with the producing apparatus according to the present embodiment includes, for example, a liquid supply pump for drawing ballast water from the ballast water reservoir, and a liquid supply pipe for connection between the liquid supply pump and a ballast water tank provided in an anchored ship.

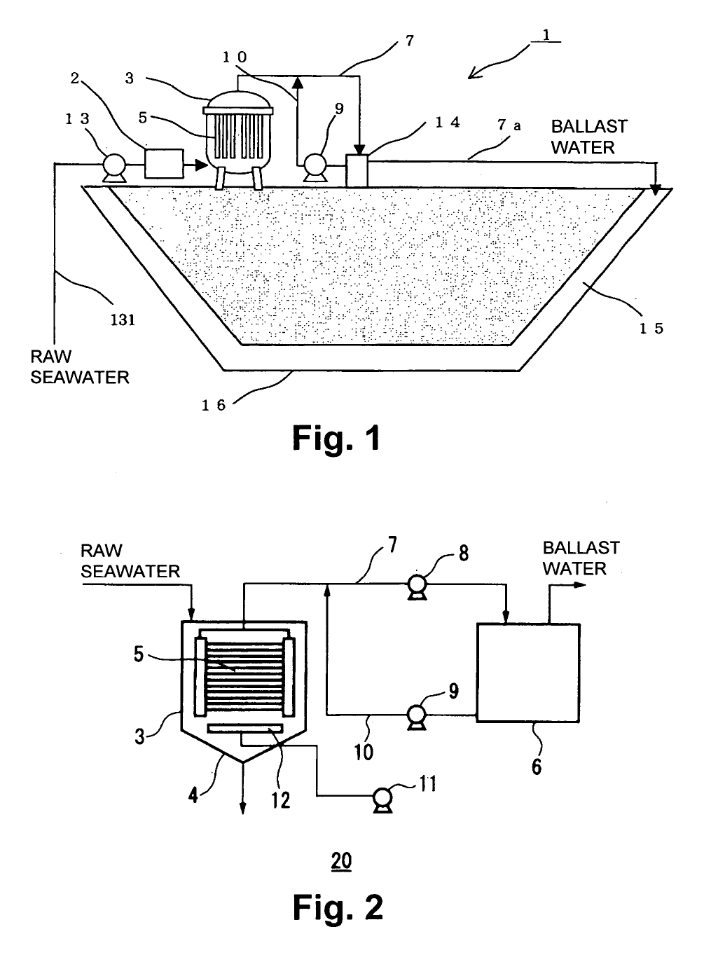

The ballast water producing apparatus of a type to be set up on a ship may have a similar structure to that of the ballast water producing apparatus of the above-described type to be set up on the ground, with the exception that provision of the ballast water reservoir may be omitted. One example of the ballast water producing apparatus to be set up on a ship will be described with reference to the schematic diagram shown in FIG. 1. A ballast water producing apparatus 1 includes a seawater supply pump 13, an oil water separation device (oil content removal device) 2, a hollow fiber membrane type microorganism filtration device 3, and a backwash water reservoir 14, which are provided, in that order, from the upstream side. A seawater intake hose 131, one end of which is positioned in the sea, is provided on the suction side of the seawater supply pump 13. The hollow fiber membrane type microorganism filtration device 3 and the backwash water reservoir 14 are connected through a treated water pipe 7, and the backwash water reservoir 14 and a ballast water tank 15 are connected through a treated water pipe 7a. In addition, a backwash water pump 9 is provided so that filtered water stored in the backwash water reservoir 14 can be delivered through a backwash water pipe 10 to backwash the above-described microfiltration membrane. A concentrated solution (not shown) discharged from the hollow fiber membrane type microorganism filtration device 3 is discarded into the sea, or onto the ground. The oil water separation device 2 may be omitted. Further, a turbidity removal device may be provided as needed, downstream of the oil water separation device 2. Further, it is possible to omit the provision of the seawater supply pump 13 having the seawater intake hose 131, and to use an already-provided ballast water supply pump (not shown) having a seawater supply port which is attached to a body 16 of the ship. In this case, because it is sufficient if the oil water separation device 2, the hollow fiber membrane type microorganism filtration device 3, the backwash water reservoir 14, and the like are provided downstream of the already-provided ballast water supply pump, the cost of construction can be reduced. The ship on which the ballast water producing apparatus 1 is to be set up is not particularly limited if the ship is provided with a ballast water tank.

According to the present embodiment, because microorganisms living in seawater that is to be used as ballast water can be effectively removed through the microorganism filtration membrane, ballast water discharged from the ship does not bring in microorganisms which did not originally live in a particular sea area, and does not cause destruction of marine environments. Further, for example, by storing membrane filtered water in the ballast water reservoir, the water can be introduced into a ship for use as ballast water when needed. Further, when the above-described steps are performed in a ship, equipment to be set up on the ground, setup space, and ground workers become unnecessary. Further, even if seawater contains a relatively high content of oil, because the oil content is pre-removed before the seawater is treated through the microorganism filtration membrane, the microorganism filtration membrane is not contaminated, and stable treatment can be performed for a long period of time.

### EXAMPLES

Next, the present invention will be described in more detail with reference to the following examples. However, these examples are given only by way of illustrative examples, and are not intended to limit the scope of the present invention.

### Example 1

Seawater in a domestic port area “A” in which a ship was staying (hereinafter, referred to as “raw seawater”) was treated by use of a ballast water producing apparatus as will be described below, and under operating conditions as will be described below. Coliform bacteria in the raw seawater and treated water (membrane filtered water) were measured by the following measurement method. It should be noted that the raw seawater had an oil content of 8 mg/L in the form of an n-hexane extract, and had a turbidity of 5 NTUs.

(Ballast Water Producing Apparatus)

An apparatus as shown in FIG. 2 was used. A ballast water producing apparatus 20 having a hollow fiber membrane type microorganism filtration device 3 as a main part, in which a hollow fiber membrane module 5, “STERAPORE SUR31534” (manufactured by Mitsubishi Rayon), made of microfiltration membranes having a treatment capacity of 3 m³ per hour, was immersed in a treatment chamber 4, was used. The hollow fiber membrane type microorganism filtration device 3 and a treated water reservoir 6 were connected through a treated water pipe 7, and the treated water pipe 7 was provided with a suction pump 8. Further, a backwash water pump 9 was provided so that filtered water stored in the treated water reservoir 6 could be delivered through a backwash water pipe 10 to backwash the above-described microfiltration membranes.

(Operating Method)

The raw seawater was supplied to the ballast water producing apparatus 20 at a treatment rate of 3 m³ per hour. In the step of removing microorganisms, filtration was performed while air supplied from a blower 11 was being caused to generate micro-bubbles from a distributor 12 provided below the hollow fiber membrane module 5 to cause microorganisms and the like adhering to a hollow fiber membrane surface to be released. The step of removing microorganisms was performed for 15 minutes, whereas the step of backwashing was performed for 1 minute, and these steps were thus repeated. A waste solution in which microorganisms were concentrated was drained as appropriate from a lower part of the treatment chamber 4 of the hollow fiber membrane type microorganism filtration device 3.

(Microorganism Measurement Method)

Coliform bacteria were measured after a sample added to a BGLB broth (brilliant green lactose bile broth) was cultured at 35° C. for 24 hours.

(Results of Treatment)

Although the number of coliform bacteria in the raw seawater was 35 per 100 mL, no coliform bacteria were detected in the treated water. Further, no n-hexane extract was detected in the treated water, and the turbidity was no greater than 2 NTUs. It should be noted that, while the differential pressure measured immediately after backwashing was performed at an early stage of filtration operation was 0.05 MPa, the differential pressure measured immediately after backwashing was performed subsequently to 170 hours of filtration operation was 0.45 MPa.

### Example 2

Example 2 was performed in the same manner as in Example 1, with the exception that the raw seawater was treated by use of a ballast water producing apparatus as will be described below, and under operating conditions as will be described below.

(Ballast Water Producing Apparatus)

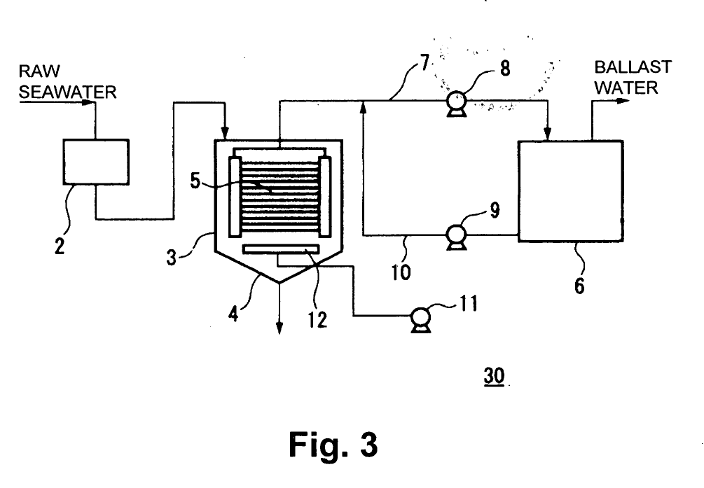

An apparatus as shown in FIG. 3 was used. A ballast water producing apparatus 30 includes an oil water separation device 2, “DIAMARS RH-03” (manufactured by Mitsubishi Rayon Engineering) having a treatment capacity of 3 m³ per hour, a hollow fiber membrane type microorganism filtration device 3, and a treated water reservoir 6, which were provided, in that order, from an upstream side. The hollow fiber membrane type microorganism filtration device 3, in which a hollow fiber membrane module 5, “STERAPORE SUR31534” (manufactured by Mitsubishi Rayon), made of microfiltration membranes having a treatment capacity of 3 m³ per hour, was immersed in a treatment chamber 4, was used. The hollow fiber membrane type microorganism filtration device 3 and the treated water reservoir 6 were connected through a treated water pipe 7, and the treated water pipe 7 was provided with a suction pump 8. Further, a backwash water pump 9 was provided so that filtered water stored in the treated water reservoir 6 could be delivered through a backwash water pipe 10 to backwash the above-described microfiltration membranes.

(Operating Method)

The raw seawater was supplied to the ballast water producing apparatus 30 at a treatment rate of 3 m³ per hour. In the step of removing microorganisms, filtration was continued while air supplied from a blower 11 was being caused to generate micro-bubbles from a distributor 12 provided below the hollow fiber membrane module 5 to cause microorganisms and the like adhering to a hollow fiber membrane surface to be released, thereby renewing the membrane surface. The step of removing microorganisms was performed for 15 minutes, whereas the step of backwashing was performed for 1 minute, and these steps were thus repeated. A waste solution in which microorganisms were concentrated was drained as appropriate from a lower part of the treatment chamber 4 of the hollow fiber membrane type microorganism filtration device 3.

(Results of Treatment)

Although the number of coliform bacteria in the raw seawater was 35 per 100 mL, no coliform bacteria were detected in the treated water. Further, no n-hexane extract was detected in the treated water, and the turbidity was no greater than 2 NTUs. It should be noted that the differential pressure measured immediately after backwashing was performed at an early stage of filtration operation was 0.05 MPa, and the differential pressure measured immediately after backwashing was performed subsequently to 170 hours of filtration operation was also 0.05 MPa. Thus, by pre-removing oil content from the raw seawater through the oil water separation device, contamination of the microfiltration membranes due to oil content could be effectively prevented.

### Example 3

Instead of the immersion type hollow fiber membrane type microorganism filtration device 3, a pressure type hollow fiber membrane type microorganism filtration device (not shown) was used, and the air-bubble washing and the periodic backwashing step were performed in the same manner as in Example 1. For a hollow fiber membrane module used in the pressure type hollow fiber membrane type microorganism filtration device, three microfiltration membranes “STERAPORE G-type UMF-2024WFA” (manufactured by Mitsubishi Rayon) having a treatment capacity of 3 m³ per hour, were used.

(Results of Treatment)

Although the number of coliform bacteria in the raw seawater was 35 per 100 mL, no coliform bacteria were detected in the treated water. Further, no n-hexane extract was detected in the treated water, and the turbidity was no greater than 2 NTUs. It should be noted that the microfiltration membrane differential pressure data was similar to that of Example 2.

As shown in the examples, by treating the raw seawater through the ballast water producing apparatus, coliform bacteria in the raw seawater were removed to the extent that no coliform bacteria were detected. Further, by providing the oil water separation device upstream of the hollow fiber membrane type microorganism filtration device, contamination of the microfiltration membranes due to oil content could be effectively prevented.

1. A process for producing ship ballast water, the process comprising the steps of:
removing microorganisms from seawater by passing the seawater through a microorganism filtration membrane; and
backwashing the microorganism filtration membrane to clean the microorganism filtration membrane.

2. A process for producing ship ballast water according to claim 1, wherein at least oil content in the seawater is pre-removed before the seawater is treated through the microorganism filtration membrane.

3. A process for producing ship ballast water according to claim 1, wherein the microorganism filtration membrane is a hollow fiber membrane.

4. A process for producing ship ballast water according to claim 2, wherein the oil content in the seawater is removed by absorption using a hydrophobic absorbent.

5. A ship ballast water producing apparatus, comprising:
seawater supply means for supplying seawater;
a microorganism filtration membrane device for removing microorganisms from the supplied seawater; and
backwash water supply means for supplying backwash water to the microorganism filtration membrane device.

6. A ship ballast water producing apparatus according to claim 5, further comprising a ballast water reservoir for storing membrane filtered water.

7. A ship ballast water producing apparatus according to claim 5, wherein an oil content removal device for removing at least oil content from the seawater is provided upstream of the microorganism filtration membrane device.

8. A ship ballast water producing apparatus according to claim 5, wherein the microorganism filtration membrane device is either an immersion type hollow fiber membrane device, or a pressure type hollow fiber membrane device.

9. Use of membrane filtered water as ship ballast water, wherein the membrane filtered water is obtained through the step of removing microorganisms in the process for producing ship ballast water according to claim 1.
